(19) United States
(12) Patent Application Publication
(10) Pub. No.: US 2011/0240824 A1
(43) Pub. Date: Oct. 6, 2011

(54) APPARATUS FOR SECURING DISPLAY OBJECTS TO POSTS

(76) Inventor: Nathon Jon Wade, Thorton (CA)

(21) Appl. No.: 12/752,539

(22) Filed: Apr. 1, 2010

(51) Int. Cl. G09F 17/00; E04H 12/32

(52) U.S. Cl. 248/541

(57) ABSTRACT

An apparatus for securing a display object to a post, having an inner member having a body, the body defining an opening sized and shaped to receive the post therein, the body having an outer portion, an adjustable securing mechanism provided in the opening for securing the inner member to the post, an outer member having an inner portion sized and shaped to engage with the outer portion of the inner member such that the outer member can rotate about the post, and at least one display support member on the outer member for securing the display object to the outer member.

### FIELD

The embodiments herein relate to apparatus for securing display objects to posts.

### INTRODUCTION

Posts are commonly used for many purposes, including for example as flagpoles and lampposts, and for supporting traffic lights. Depending on their use, location, and design, posts may be of many different sizes and shapes. For example, a post may be circular and have a uniform diameter along the length of the post. In other examples, a post may have a circular cross-section but be tapered such that the diameter of the post varies along its length. A post may also be non-circular in shape. For example, a post may have a square, rectangular, pentagonal, hexagonal or oval cross-section, or may have other cross-sectional shapes.

In some cases the post has a post surface that may be uneven along at least some of the length of the post. For example, at least a portion of the post surface may be angled. Furthermore, in some cases the post surface may feature one or more decorative elements that may render the post surface uneven or irregular.

A post may be used to mount a flag, banner, sign or other display object such that the display object is disposed at a distance above a ground surface. This generally permits a more prominent display of the display object. In particular, the display object may include some graphical elements thereon which are desired to be displayed, which could be a message (e.g. advertising), artistic elements (e.g. artwork or a design), or other graphical elements. Positioning the display object with the graphical elements at a distance from the ground surface is generally desirable so that the graphical elements can be clearly seen.

When a display object is mounted on a post, the display object may be impacted by wind. For example, in some circumstances, wind blowing against the display object on a post can cause the display object to furl, which may inhibit the display object from effectively displaying any graphical elements thereon. Wind may also generate stress on mounting structures that mount the display to the post, which is generally undesirable. In some situations, it may also be desirable to know the direction of the wind. For example, it may be desirable that the display object responds to the direction of the wind with some type of movement.

Generally, various apparatus are known for securing display objects to posts. For example, U.S. Pat. No. 4,402,220 issued to Kuhlmann et al. teaches a wind direction indicator for sailing vessels, particularly wind surfers or small yawls and uses a weather vane pivoted to one end of an outrigger. The outrigger is to be fitted to the mid-height of the mast in the angle of vision of the yachtsman using a clamping device. In the case of a rotatable mast or a sail surrounding the mast, the outrigger can rotate in such a manner as a function of the sail position that the wind direction indicator is always on the windward side of the sail.

As another example, U.S. Pat. No. 5,203,672 issued to Wolf teaches a wind turbine with a stationary tower and a set of turbine blades rotatably attached to the top and bottom of the tower. A set of upper and lower braces connect the turbine blades to prevent any sag or skewing of the turbine blades as they rotate about the tower. The wind turbine may also include a stationary shell attached to the tower and inside the sweep of the turbine blades, to direct the airflow toward the turbine blades at the shell periphery, thereby improving overall performance and efficiency of the turbine.

Furthermore, U.S. Pat. No. 5,361,633 issued to Peet teaches an apparatus for measuring wind speed and direction that includes a wind vane having a permanent magnet, an anemometer having a permanent magnet and a ferromagnetic member, and a stationary housing having radially and axially mounted reed switches. As the anemometer spins, the anemometer magnet closes the radially mounted reed switch once per revolution. This produces a signal having a frequency proportional to wind speed. The wind vane magnet rotates around the housing to a point determined by the wind direction, producing enough flux to keep the axially mounted reed switch closed. The housing has a mounting assembly including tapered, grooved mounting members, and a locking collar with a circumferential land to engage the grooves. The housing may be mounted at any azimuthal angle. Calibration compensates for the mounting angle.

Finally, U.S. Pat. No. 7,270,076 issued to Evans teaches a flag pole mounted unfurling device installed on a flagpole and which rotates to minimize unwanted furling of the flag. The device includes a lower swivel, an upper swivel, and a baton that extends between the lower swivel and the upper swivel to retain the two swivels in alignment and properly separated. The upper swivel and lower swivel are free to rotate around the axis of the pole while the baton serves to couple the upper and lower swivels together, both rotationally and longitudinally. The entire assembly is longitudinally retained on the pole by an upper collar and a lower collar and minimizes the unwanted furling of a flag through dynamic instability.

Nevertheless, there remains a need for an improved apparatus for securing display objects to a post.

### SUMMARY

According to one aspect, there is provided an apparatus for securing a display object to a post comprising an inner member having a body, the body defining an opening sized and shaped to receive the post therein, the body having an outer portion; an adjustable securing mechanism provided on the body and extending into the opening for securing the inner member to the post; an outer member having an inner portion sized and shaped to engage with the outer portion of the inner member such that the outer member can rotate about the post; and at least one display support member on the outer member for securing the display object to the outer member.

The body of the inner member may comprise at least two connectable segments, the segments movable between an open position wherein at least two ends of the segments are spaced apart such that the post may pass therebetween and a closed position wherein the ends of the segments are connected together.

The at least one of the segments of the inner member may be connected to at least one other segment of the inner member, the segments being movable between the open position and the closed position.

In some embodiments, the at least two segments of the inner member comprises a first segment and a second segment, the first segment being connectable to the second segment, and the segments being movable between the open position and the closed position.

In some embodiments, the first segment of the inner member is configured to be hingedly connectable to the second segment of the inner member to permit hinged movement between the open position and the closed position.

In some embodiments, the outer member comprises at least two connectable segments, the segments movable between an open position wherein at least two ends of the segments are spaced apart such that the outer member may be secured around the inner member and a closed position wherein the ends of the segments are connected together.

In some embodiments, the at least one of the segments of the outer member is connected to at least one other segment of the outer member, the segments being movable between the open position and the closed position.

The at least two segments of the outer member may comprise a first segment and a second segment, the first segment being connectable to the second segment, and the segments being movable between the open position and the closed position. The first segment of the outer member may be configured to be hingedly connectable to the second segment of the outer member to permit hinged movement between the open position and the closed position.

The adjustable securing mechanism may include at least one member configured to move inwardly and outwardly within the opening. The at least one member may comprise at least one threaded fastener provided within at least one threaded bore in the body of the inner member, the at least one threaded fastener movable within the at least one bore to secure the body of the inner member to the post.

In some embodiments, at least one of the inner member and the outer member further comprises at least one roller having a rolling surface, the rolling surface being exposed to a roller engagement portion of at least one of the inner member and the outer member such that the outer member is rotatable around the inner member when the inner portion of the outer member engages the inner member. The inner member may comprise the at least one roller and the roller engagement portion being the inner portion of the outer member. At least one of the inner member and the outer member may further comprise a roller engagement feature complementary to the at least one roller, the roller engagement feature being in contact with the roller when the inner member is coupled to the outer member.

In some embodiments, the at least one roller has a recess defined therein, and the roller engagement feature complementary to the at least one roller comprises the inner portion of the outer member having an annular ridge adapted to engage the recess in the at least one roller.

The at least one roller may comprise at least one generally spherical roller, and the roller engagement feature may comprise an annular channel adapted to receive the at least one generally spherical roller.

The at least one roller may be removably coupled to the at least one of the inner member and the outer member.

In some embodiments, the at least one support member comprises at least one arm coupleable to the display object. The support member may comprise a first arm extending outwardly from the post and a second arm extending generally along the post.

The apparatus may further comprise an arm support member, the arm support member having a post engagement portion sized and shaped to engage a post and arm engagement portion sized and shaped to engage a distal end of the second arm.

Other aspects and features will become apparent, to those ordinarily skilled in the art, upon review of the following description of some exemplary embodiments.

### BRIEF DESCRIPTION OF THE DRAWINGS

The embodiments herein will now be described, by way of example only, with reference to the following drawings, in which:

FIG. 1 is a perspective view of a apparatus for securing a banner or other display object to a post according to one embodiment;

FIG. 2 is a perspective view of the apparatus of FIG. 1;

FIG. 3 is an exploded perspective view of the apparatus of FIG. 1;

FIG. 4 is a bottom view of an inner member and an outer member of the apparatus of FIG. 1 shown partially disassembled;

FIG. 5 is a perspective view of a second segment of the inner member shown in FIG. 4;

FIG. 6 is a cross-sectional side view of the outer member shown in FIG. 4;

FIG. 7 is a schematic diagram of a roller and a roller engagement feature of the apparatus shown in claim 1; and

FIG. 8 is a schematic diagram of a roller and a roller engagement feature of an apparatus for securing a display object to a post according to another embodiment.

### DESCRIPTION OF VARIOUS EMBODIMENTS

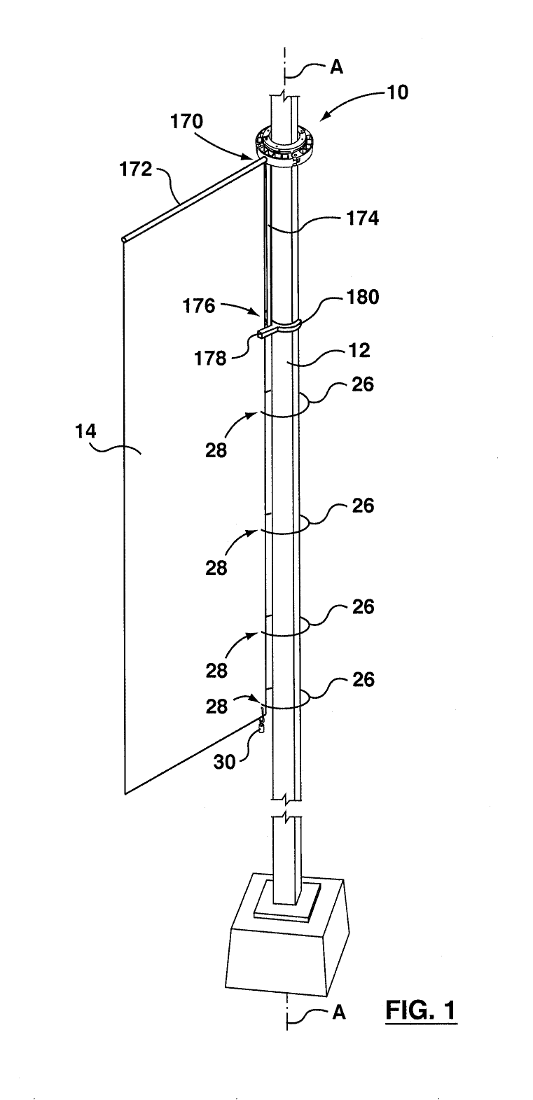

Referring to FIG. 1, illustrated therein is an apparatus 10 for securing a display object to a post according to one embodiment. In particular, the apparatus 10 is generally shown assembled and mounted on a post 12 and secured to a display object 14.

The display object 14 may be a flag, a banner, a sign or any other type of display object of various shapes and size, and may be constructed of different materials such as various types of textiles, paper, metal, plastics, rubber, and may be flexible or rigid.

As shown, the post 12 is generally an elongate member that extends upwardly from a ground surface. In this embodiment, the post 12 has a rectangular cross section. However, the apparatus 10 may be mounted to posts that have cross sections of other shapes and sizes. For example, the apparatus 10 may be mounted on a post with a circular, oval, pentagonal, hexagonal, octagonal, or irregular cross section, or other suitable shapes.

As shown, the cross section of the post 12 is even along the length of the post 12 (e.g. along the longitudinal axis A of the post 12). However, in other embodiments the apparatus 10 may be mounted on a post that has different cross sectional sizes and shapes along its length. For example, the post 12 could be tapered so as to be wider at a lower end (e.g. closer to the ground surface) and narrower at an upper end (e.g. away from the ground surface).

As shown, in this embodiment the longitudinal axis A of the post 12 is perpendicular to the ground surface. However, the apparatus 10 may be mountable to a post that is oriented at other angles relative to the ground. Furthermore, in some embodiments the post 12 could be curved or have an irregular longitudinal shape such that the angle of the post 12 with respect to the ground surface may vary along its length.

In some embodiments, the post 12 may be secured to another surface. For example, the post 12 could be secured to a portion of a building.

Generally, the apparatus 10 is configured so as to be mountable to a post with an uneven exterior surface. For example, factors such as dirt, rust, debris, or warping of the post surface may cause the post surface to be uneven. Similarly, intentional factors such as decorative elements or the design of the shape of the post may also cause the post surface to be uneven.

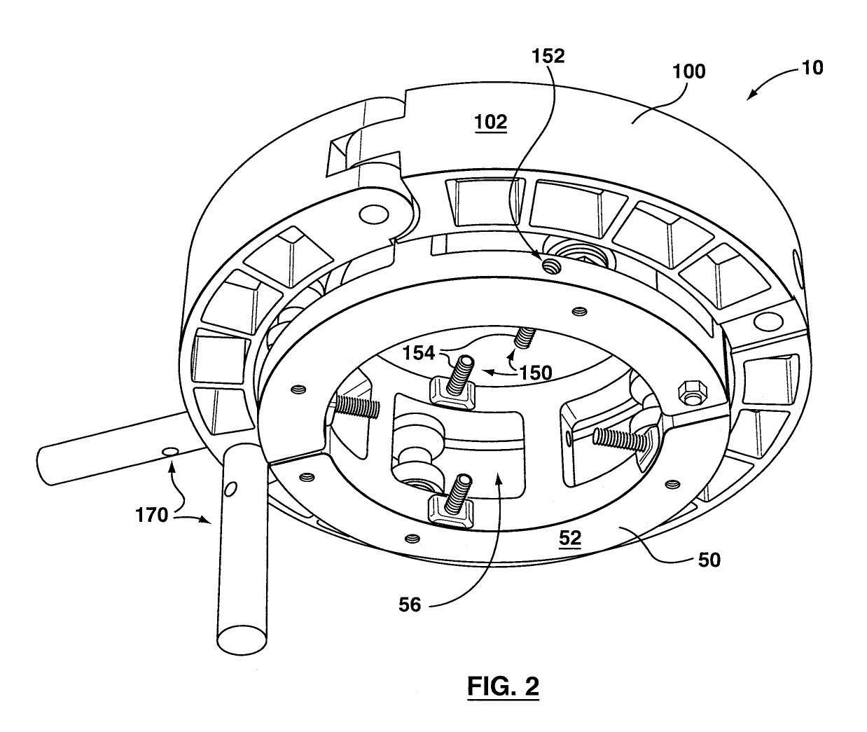

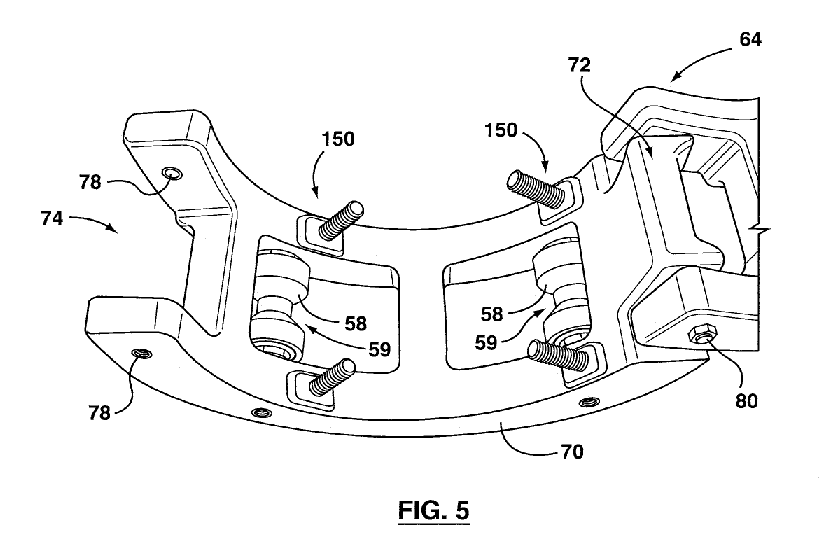

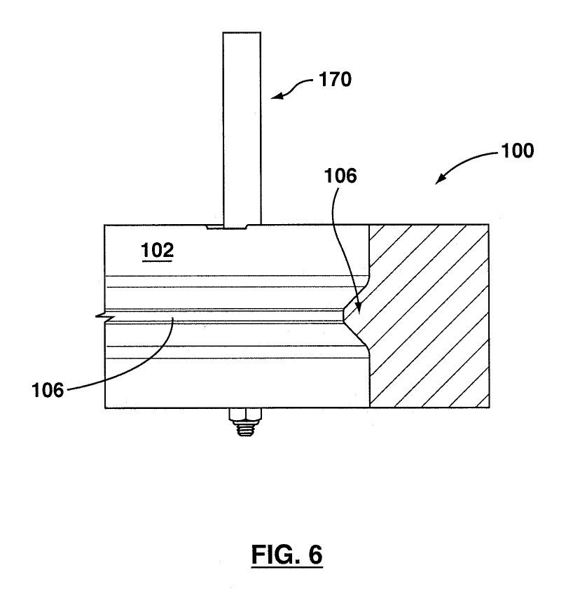

Referring now generally to FIGS. 2 to 8, the apparatus 10 generally has an inner member 50 that is sized and shaped to be secured to the post 12 using an adjustable securing mechanism 150, an outer member 100 sized and shaped so as to be rotatably coupled to the inner member 50, and at least one display support member 180 for supporting at least one display object 14.

The inner member 50 has a body indicated generally by reference numeral 52, and the body 52 has an outer portion generally indicated by reference numeral 54. The body 52 defines an opening 56 which is sized and shaped to receive the post 12 therein. In particular, the opening 56 may be sufficiently large so as to accommodate posts of various shapes and sizes.

Generally, the adjustable securing mechanism 150 is provided on the body 52 so as to be extendable into the opening 56 for rigidly securing the inner member 50 to the post 12.

Turning now to the outer member 100, the outer member 100 also has a body indicated generally by reference numeral 102. The body 102 has an inner portion indicated generally by reference numeral 104, and which is sized and shaped to engage with the outer portion 54 of the inner member 50 to secure the outer member 100 to the inner member 50. In particular, the inner portion 104 and outer portion 54 generally cooperate to allow the outer member 100 to rotate about the inner member 50 (and about the post 12) when the inner member 50 and outer member 100 are coupled together.

As shown, the body 52 of the inner member 50 may be generally annular or “ring-shaped”. Furthermore, the outer portion 54 of the inner member 50 is generally circular in shape to allow rotation of the outer member 100 about the inner member 50.

The opening 56 in the illustrated embodiment has a circular shape and is large enough to receive the post 12 therein. However, the shape of the opening 56 may be different. In particular, the size and the shape of the opening 56 are normally selected so as to be larger than the perimeter of the post 12 such that the post 12 may be received within the opening 56 while allowing the adjustable securing mechanism 150 to secure the inner member 50 to the post 12.

It is not necessary for the size or shape of the opening 56 to correspond to the size or shape of the perimeter of the post 12. For example, the opening 56 could be rectangular while the post 12 is circular, or vice versa, and this difference can be accommodated by the adjustable securing mechanism 150.

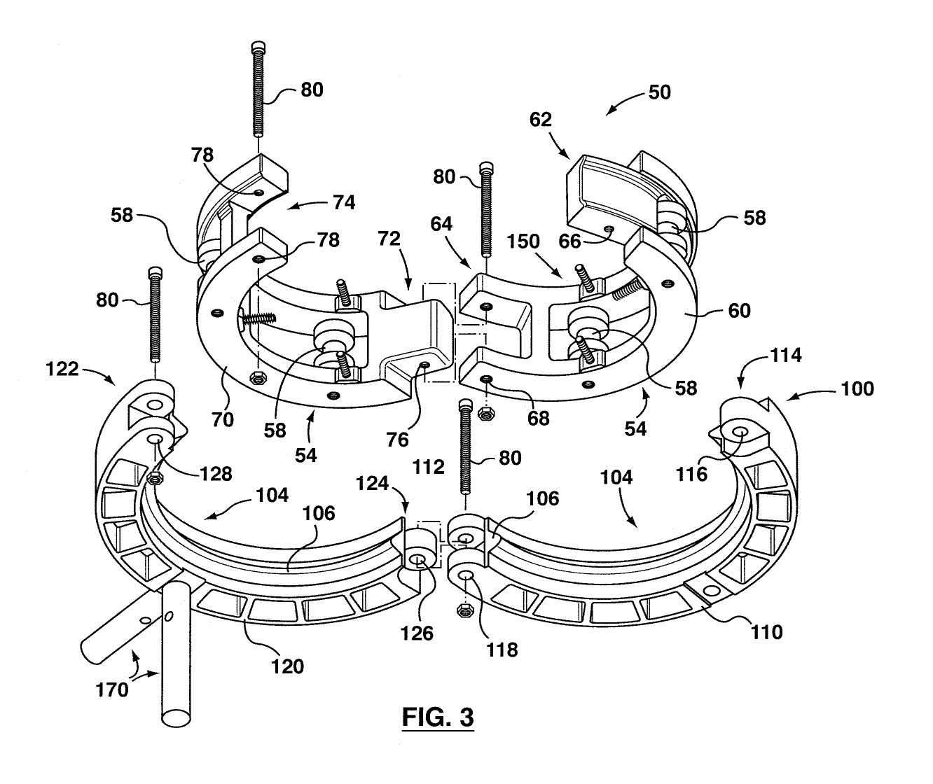

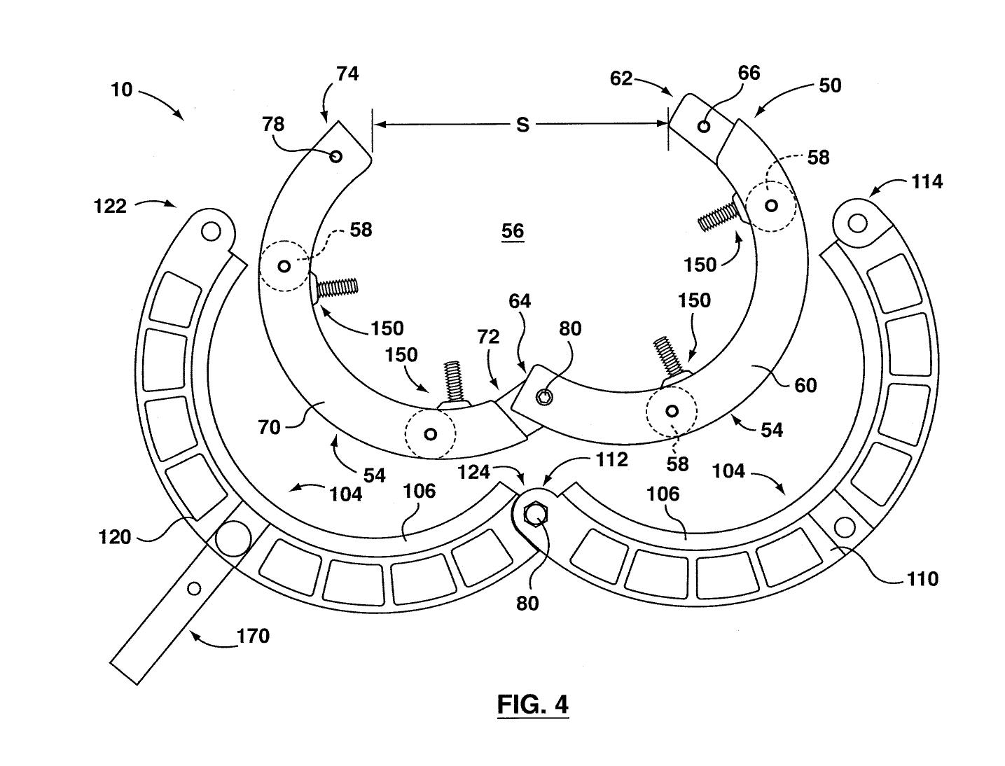

As shown, in this embodiment the inner member 50 has at least two segments coupled together to form the body 52. At least one of the segments (e.g. a first segment 60) is connectable to at least one other segment (e.g. a second segment 70), and the segments 60, 70 are movable between an open position (shown in FIGS. 3 and 4) and a closed position (shown in FIG. 2).

In the open position, at least two ends of the segments 60, 70 are spaced apart such the post 12 can pass between two ends of the segments 60, 70 to receive the post 12 within the opening 56 (or to remove the post 12 from the opening 56). For example, as shown in FIG. 4, the first segment 60 and the second segment 70 have ends 62, 64, and 72, 74 respectively. The ends 62, 74 of the first and second segments 60, 70 are spaced apart a distance S (distance S being larger than the width of the post 12) to receive the post 12 in the opening 56. However, in the closed position, the ends 62, 74, and 64, 72 of the segments 60, 70 are connected together such that the post 12 may not pass therebetween (e.g. the post 12 is secured within the opening 56).

In other embodiments, the inner member 50 may have more than two segments. For example, in inner member 50 may have three segments, four segments, or more segments.

In some embodiments, the first segment 60 and the second segment 70 of the inner member 50 are semi-annular in shape (e.g. each segment comprises half of the “ring”). In other embodiments, the shape of the segments 60 and 70 may differ. For example, the shape of the segments 60 and 70 may differ depending on the shape of the body 52 and or the number of segments.

As shown the first segment 60 is generally the same size and shape as the second segment 70. However, in other embodiments the first segment 60 may have a different size or shape (or both) as compared to the second segment 70. For example, the first segment 60 may be larger than the second segment 70, or vice versa.

Generally, the segments 60 and 70 of the inner member 50 are connectable to each other at the opposing ends.

In the embodiment as shown, the first end 64 of the first segment 60 has a U-shaped clevis end portion. Similarly, the first end 74 of the second segment 70 also has a U-shaped clevis end portion. The second end 62 of the first segment 60 has a protrusion or tang that is sized and shaped to be received in the clevis end 74 of the second segment 70. Similarly, the second end 72 in the second segment 74 has a protrusion or tang that is sized and shaped to be received in the clevis end 64 of the first segment 60.

In the embodiment as shown, each end 62, 64, 72, 74 has bores defined therein for use in cooperation with pins, bolts or other threaded fasteners for securing the segments 60, 70 together. For example, the ends 62 and 72 may have bores 66 and 76 defined within the tang ends 62, 72, while the clevis ends 64 and 74 may have bores 68 and 78 defined therein.

To connect the segments 60 and 70 together, the tang end from one segment (e.g. the second end 72 of the second segment 70) may be received within the clevis end in the other segment (e.g. the first end 64 of the first segment 60) such that the bore 76 within the tang is aligned with the bores 68 in the clevis end. A fastener 80 may then be placed through the bores 62 and 64 to connect the segments 60 and 70 together (and which may allow the segments 60, 70 to hingedly pivot with respect to each other). For example, as shown a nut and bolt type fastener may be used. In other embodiments, the bores may be threaded and a threaded fastener may be used. In other embodiments, other mechanisms for connecting the segments may be used.

This coupling may generally permit hinged movement of the segments 60, 70 between the open position and the closed position, which may ease the mounting and the demounting of the apparatus 10 on the post 12.

Turning now to the adjustable securing mechanism 150, as described above the adjustable securing mechanism 150 is generally provided on the body 52 and is configured so as to be extendable into the opening 56 for securing the inner member 50 to the post 12. In particular, the adjustable securing mechanism 150 generally allows the apparatus 10 to be mounted to post of varying shapes and sizes, and can accommodate irregular or uneven post surfaces.

The adjustable securing mechanism 150 generally includes at least one member coupled to the body 52 and configured to move inwardly and outwardly within the opening 56, generally transversely with respect to the longitudinal axis A of the post 12 so as to contact the surface of the post 12. In some cases, the at least one member is configured to move radially inwardly and outwardly.

In the embodiment shown, the adjustable securing mechanism 150 includes threaded fasteners 154 that are sized and shaped to be received in threaded bores 152 provided within the body 52. The threaded fasteners 154 can be adjusted (e.g. moved transversely inwardly and outwardly) to secure the body 52 of the inner member 50 to the outer surface of the post 12. That is, when a post 12 is received within the opening 56 of the inner member 50, the fasteners 154 may be adjusted in the bores 152 to engage with the post 12 and to secure the inner member 50 to the post 12. Accordingly, the adjustable securing mechanism 150 may be used with posts of various shapes and sizes.

As shown, in some embodiments the bores 152 and fasteners 154 may be placed in vertically aligned pairs, may be spaced evenly apart within the opening 56, or both. This vertical alignment and spacing may provide for good securing of the inner member 50 to the post 12, and may inhibit the inner member 50 from tipping or becoming misaligned during use. Furthermore, providing a plurality of bores 152 and fasteners 154 within the opening 56 may allow for accommodating posts 12 having very irregular sizes and shapes.

In the embodiment as shown, eight bores 152 and eight threaded fasteners 154 are provided (e.g. four vertically aligned pairs of fasteners 154 and bores 152 are provided).

In other embodiments, the number and location of the bores 152 and fasteners may differ. For example, the bores 152 and fasteners 154 may be placed in one or more staggered patterns such that a particular bore is not necessarily opposite another bore when the inner member 50 is in the closed position.

Referring now to FIGS. 1, 3 and 4, the apparatus 10 also includes the outer member 100. The outer member 100 is configured to rotate about the inner member 50 when in use.

The outer member 100 as shown has an annular body indicated generally as reference numeral 102. The body 102 has an inner portion indicated generally as reference numeral 104, and which is generally sized and shaped to engage with the outer portion 54 of the inner member 50 such that the outer member 100 can rotate about the inner member 50 (and accordingly about the post 12).

The inner portion 104 of the outer member 100 in this embodiment has a rounded shape that corresponds to the round shape of the outer portion 54 of the inner member 50. However, in other embodiments the size and shape of the inner portion 104 may differ. For example, the size and shape of the inner portion 104 need not correspond to the outer portion 54 as long as it permits rotation of the outer member 100 about the inner member 50.

In particular, rollers and roller engagement features, as described below, may permit the rotation of the outer member 100 with respect to the inner member 50 even if the shape of the inner portion 104 does not correspond to the outer portion 54.

In this embodiment, the outer member 100 has at least two segments configured to be decoupled from each other to receive the inner member 50 therein. At least one of the segments (e.g. a first segment 110) is connected to at least one other segment (e.g. a second segment 120), and the segments 110, 120 are movable between an open position and a closed position. As shown, each segment 110 and 120 has ends 112, 114, and 122, 124 respectively.

In the open position, at least two ends 114, 122 of the segments, 110, 120 are spaced apart such that the outer member 100 may be secured around the inner member 50. In the closed position, the ends 114, 122 of the segments 110, 120 are connected together such the inner member 50 and outer member 100 may be secured together.

In other embodiments, the outer member 100 may have more than two segments. For example, the outer member 100 may have three segments, four segments, or more segments.

As shown, the first segment 110 and the second segment 120 of the outer member 100 may be semi-annular in shape (e.g. each segment 110, 120 is half of a “ring”). However in other embodiments, the shape of the segments 110 and 120 may differ depending on the shape of the outer member 100.

As shown, the first segment 110 may be of the same size and shape as the second segment 120. However, in other embodiments the first segment 110 and second segment 120 may have different sizes or shapes, or both.

The segments 110 and 120 of the outer member are connectable to each other at their opposing ends. As shown, each of the segments 110 and 120 has two ends 112, 114, and 122, 124 respectively. The first end 112 of the first segment 110 has a U-shaped clevis end portion. Similarly, the first end 122 of the second segment 120 has a U-shaped clevis end portion. The second end 114 of the first member 110 has a protrusion or tang that is sized and shaped to be received within the clevis end 122 of the second segment 120. Similarly, the second end 124 of the second member 120 has a protrusion or tang sized and shaped to be received within the clevis first end 112 of the first segment 110.

Similar to as described above, each of the ends 114 and 124 may have a bore 116 and 126, respectively, within the body of the protrusion. Furthermore, each of the ends 112 and 122 may have a bore 118 and 128, respectively, within the clevis ends. The bores 116, 118, 126, 128 may be used in cooperation with pins, bolts or other fasteners to secure the segments 110, 120 together.

For example, the protrusion from one segment (for example the second end 124 of the second segment 120) may be received within the clevis end (e.g. first end 112 of the first segment 110) in the other segment such that the bore 126 within the protrusion is aligned with the bores 118 in the clevis end. A fastener may then be placed through the bores 126 and 118 to connect the segments 110, 120 together, and which may allow the segments 110, 120 to hingedly pivot with respect to each other. For example, a nut and bolt type fastener such as the fastener 80 may be used. In other embodiments, the bores may be threaded and a threaded fastener may be used. In other embodiments, other mechanism for connecting the segments 110, 120 may be used.

The hinged movement of the segments 110, 120 may ease the coupling and the decoupling of the outer member 100 to and from the inner member 50.

In some embodiments, at least one of the inner member 50 and the outer member 100 has at least one roller having a rolling surface thereon. The rolling surface is exposed to at least one complementary engagement portion provided on the other of the inner member 50 and the outer member 100, such that the outer member 100 is rotatable around the inner member 50 when they are coupled together.

For example, the outer member 100 may have a roller engagement feature 106 complementary to at least one roller 58 provided on the outer portion 54 of inner member 50. The roller engagement feature 106 may be in rolling contact with the at least one roller 58 when the inner member 50 is coupled to the outer member 100 such that the outer member 100 may rotate around the inner member 50.

In some embodiments, the complementary roller engagement feature may be provided on whichever of the inner member 50 or the outer member 100 that does not have rollers. If both the inner member 50 and the outer member 100 have rollers, then the complementary roller engagement feature may be provided on one or both of the members 50 and 100.

The at least one roller and the roller engagement feature may also be used to couple the inner member 50 to the outer member as described below (e.g. the rollers and roller engagement feature may cooperate to inhibit the outer member 100 from falling off of the inner member 50).

In the illustrated embodiment, the inner member 50 has the rollers 58 thereon. In particular, four rollers 58 are shown pivotally secured to the body 52, and which are evenly spaced around the opening 56. In other embodiments, the number and position of the rollers 58 may vary.

As shown, in some embodiments each roller 58 has a stationary core (e.g. an axle that is secured to the body 52), and a rotatable outer surface coupled to the stationary core. The stationary core may have a threaded bore defined therein which may be used to secure each roller 58 to the body 52 using threaded fasteners. This permits the rollers 58 to be removed. In other embodiments, other mechanisms for securing the rollers 58 to the body 52 may be used.

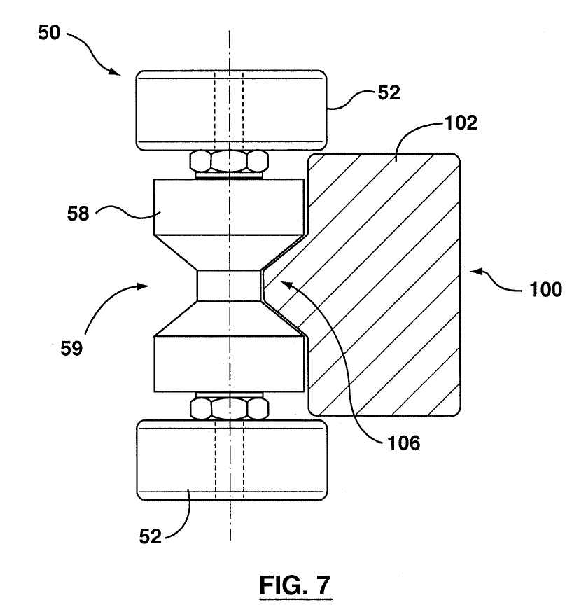

Referring to FIG. 7, the rollers 58 have a recessed portion 59 or profile, while the roller engagement feature 106 on the outer member 100 is shaped as an annular ridge on the inner portion 104. The annular ridge 106 is adapted to engage the recessed portion 59 in the rollers 58 to secure the inner member 50 the outer member 100 (e.g. inhibiting movement along the longitudinal axis A of the post 12) while allowing the outer member 100 to rotate relative to the inner member 50 (the inner member 50 being fixed to the post 12).

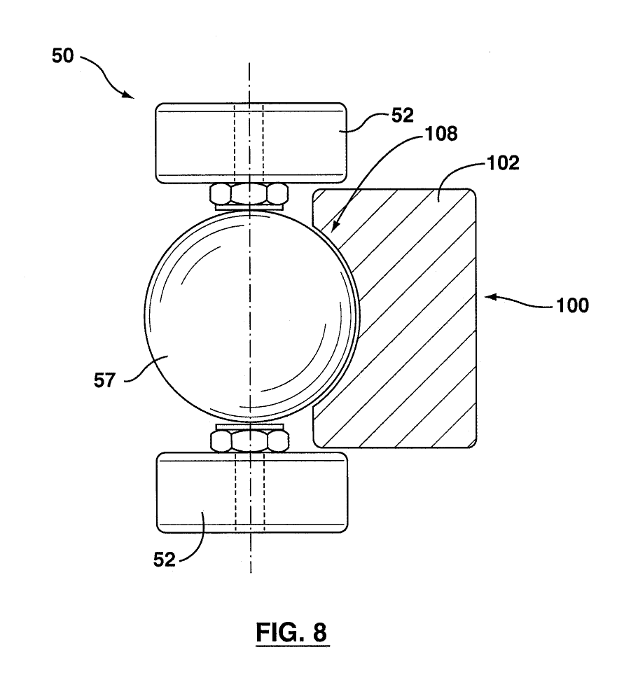

Referring to FIG. 8, in another embodiment the rollers on the inner member 50 may comprise at least one generally spherical roller 57, and the roller engagement feature on the outer member 100 may comprise an annular channel 108 adapted to receive the at least one roller 57.

In some embodiments, the rollers may be provided on the outer member 100, while the roller engagement feature may be provided on the inner member 50. In other embodiments, both the inner member and the outer member may each comprise both the rollers and the roller engagement member.

Referring now again to FIG. 1, the apparatus 10 also includes at least one support member 170 for securing the display object 14 to the outer member 100.

For example, the support member 170 in this embodiment includes arm connectors that may be connected to a first arm 172 and a second arm 174.

The first arm 172 may extend outwardly away from the post 12 (e.g. radially outwardly from the longitudinal axis A), while the second arm 174 may extends downwardly along the length of the post 12 (e.g. generally aligned with or parallel to the longitudinal axis A).

In other embodiments, the support member 170 may be include a different number of arms, or may not be an arm at all. For example, a fastener may be used to secure a display object 14 to the apparatus 10.

During use, as wind contacts the display object 14, the apparatus 10 will tend to allow the display object 14 to rotate about the post 12 (e.g. by allowing the outer member 100 to rotate about the inner member 50). Accordingly, undesirable furling of the display object will tend to be inhibited.

Furthermore, the display object 14 may also tend to indicate the relative direction of the wind, with the display object 14 generally rotating around the post 12 so as to point down-wind.

In the embodiment as shown in FIG. 1, the display support member 170 may include an arm support member 176 that supports the second arm 174. The arm support member 176 has a post engagement portion 180 sized and shaped to engage the post 12. The post engagement portion 180 may be shaped to permit rotation around the post 12. The arm support member also has an arm engagement portion 178 sized and shaped to engage the distal end of the second arm 174. The arm support member 176 helps to secure the second 174 to the post 12.

In some embodiments, the arm support member 176 may be similar to or the same as apparatus 10 as described herein.

The display object 14 may be further secured to the post 12 using annular securing members 26 that may be loosely secured around the post 12. The annular securing members 26 may be placed through apertures 28 in the display object 14 and wrap around the post 12 but be loose fitting so as not to interfere with rotation of the apparatus 10 and the display object 14. This permits rotation of the display object 14 around the post 12.

The number of annular securing members 26 may differ. For example, an annular securing member 26 may not be used at all. In another example, four or more annular securing members 26 may be used.

In some embodiments, a weight 30 is secured to the display object 14. The weight 30 may inhibit the display object 14 from furling upwards.

While the embodiments described herein may refer to various directional qualifiers such as height, length, width, sideways, upper, lower, bottom, top, horizontal or vertical, these directions are merely for illustrative purposes and are not intended to limit the scope of the invention. In some embodiments, the various elements may be oriented in different directions.

What has been described is merely illustrative of the application of the principles of the embodiments. Other arrangements and methods can be implemented by those skilled in the art without departing from the spirit and scope of the embodiments described herein.

1. An apparatus for securing a flexible flag to a post comprising:
a) an inner member having a body, the body defining an opening sized and shaped to receive the post therein and having an outer portion;
b) an adjustable securing mechanism provided on the body and extending into the opening for securing the inner member to the post;
c) an outer member having an inner portion sized and shaped to engage with the outer portion of the inner member such that the outer member is rotatable about the post
d) a flexible flag; and
e) at least one flag support member coupled to the outer member, the flag support member adapted to secure the flexible flag to the outer member, the flag support member having a first horizontal arm extending horizontally outwardly from the post and a second vertical arm spaced apart from the post and extending downwardly from the first horizontal arm generally along the post, the first horizontal arm and second vertical arm forming a support frame for securing the flexible flag to the post in an unfurled position;
e) wherein at least one of the inner member and the outer member comprises a plurality of vertically aligned rollers, each roller having a rolling surface, the rolling surface being exposed to a roller engagement portion of at least one of the inner member and the outer member, and wherein the outer member is sized and shaped such that the rolling surface rotatably supports the outer member and secures the outer member to the inner member.

2. The apparatus of claim 1, wherein the body of the inner member comprises at least two connectable segments, the segments movable between an open position wherein at least two ends of the segments are spaced apart such that the post may pass therebetween and a closed position wherein the ends of the segments are connected together.

3. The apparatus of claim 2, wherein the at least one of the segments of the inner member is connected to at least one other segment of the inner member, the segments being movable between the open position and the closed position.

4. The apparatus of claim 3, wherein the at least two segments of the inner member comprises a first segment and a second segment, the first segment being connectable to the second segment, and the segments being movable between the open position and the closed position.

5. The apparatus of claim 4, wherein the first segment of the inner member is configured to be hingedly connectable to the second segment of the inner member to permit hinged movement between the open position and the closed position.

6. The apparatus of claim 1, wherein the outer member comprises at least two connectable segments, the segments movable between an open position wherein at least two ends of the segments are spaced apart such that the outer member may be secured around the inner member and a closed position wherein the ends of the segments are connected together.

7. The apparatus of claim 6, wherein the at least one of the segments of the outer member is connected to at least one other segment of the outer member, the segments being movable between the open position and the closed position.

8. The apparatus of claim 6, wherein the at least two segments of the outer member comprises a first segment and a second segment, the first segment being connectable to the second segment, and the segments being movable between the open position and the closed position.

9. The apparatus of claim 8, wherein the first segment of the outer member is configured to be hingedly connectable to the second segment of the outer member to permit hinged movement between the open position and the closed position.

10. The apparatus of claim 1, wherein the adjustable securing mechanism includes at least one member configured to move inwardly and outwardly within the opening.

11. The apparatus of claim 10 wherein the at least one member comprises at least one threaded fastener provided within at least one threaded bore in the body of the inner member, the at least one threaded fastener movable within the at least one bore to secure the body of the inner member to the post.

12. (canceled)

13. The apparatus of claim 1, wherein the inner member comprises the at least one roller and the roller engagement portion is provided on the inner portion of the outer member.

14. The apparatus of claim 1, wherein at least one of the inner member and the outer member further comprises a roller engagement feature complementary to the at least one roller, the roller engagement feature being in contact with the roller when the inner member is coupled to the outer member.

15. The apparatus of claim 14, wherein the at least one roller has a recessed portion defined therein, and the roller engagement feature complementary to the at least one roller comprises the inner portion of the outer member having an annular ridge adapted to engage the recessed portion in the at least one roller.

16. The apparatus of claim 14, wherein the at least one roller comprises at least one generally spherical roller, and the roller engagement feature comprises an annular channel adapted to receive the at least one generally spherical roller.

17. The apparatus of claim 13, wherein the at least one roller is removably coupled to the at least one of the inner member and the outer member.

18. (canceled)

19. (canceled)

20. The apparatus of claim 1, wherein the apparatus further comprises a removable arm support member, the arm support member having a post engagement portion sized and shaped to engage a post and arm engagement portion sized and shaped to engage a distal end of the second arm.

21. The apparatus of claim 16, wherein the roller is adapted to rotate about an axis generally along the same direction as the length of the post inner member, the outer member is sized and shaped to fit around the inner member, and the generally spherical roller and the annular channel rotatably support and secure the outer member to the inner member when the outer member is engaged to the inner member.

22. The apparatus of claim 16, wherein the roller is adapted to rotate about an axis along the same direction as the length of the post inner member and the outer member are sized and shaped such that the annular ridge and the recessed portion of the rollers rotatably support and secure the outer member to the inner member.
